(19) United States
(12) Patent Application Publication
(10) Pub. No.: US 2009/0003182 A1
(43) Pub. Date: Jan. 1, 2009

(54) OPTICAL DISC APPARATUS WITH OPTICAL HEAD UNIT

(76) Inventors: Hideaki OKANO, Yokohama-shi (JP); Katsuo IWATA, Yokohama-shi (JP); Kazuhiro NAGATA, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/146,840

(22) Filed: Jun. 26, 2008

(30) Foreign Application Priority Data
Jun. 29, 2007 (JP) 2007-173052

(51) Int. Cl. G11B 7/00

(52) U.S. Cl. 369/112.01; G9B/7

(57) ABSTRACT

According to one embodiment, an APC photodetector accepts a light beam branched from a light beam toward a recording medium by a branching mirror and detects intensity of a light beam supplied from a light source, a light quantity adjusting element adjusts the intensity of the light beam, and the intensity of the light beam incident to the APC photodetector is changed in a continuous manner or a stepwise manner by the light quantity adjusting element. Therefore, when the single APC photodetector detects recording and reproducing light beams, the recording and reproducing light beams can fall within a dynamic range of the APC photodetector.

### CROSS-REFERENCE TO RELATED APPLICATIONS

This application is based upon and claims the benefit of priority from Japanese Patent Application No. 2007-173052, filed Jun. 29, 2007, the entire contents of which are incorporated herein by reference.

### BACKGROUND

1. Field

One embodiment of the invention relates to an optical head device and an optical disc apparatus which monitor laser beam intensity to prevent a light quantity control circuit, which reflects the laser beam intensity on a laser element driving current, from being saturated depending on the laser beam intensity, whereby stable APC control can be performed irrespective of a kind of an optical disc.

2. Description of the Related Art

An information-recording medium, that is, an optical disc in which information can be recorded and reproduced using a laser beam has long been put into practical use. For an optical disc standard, the Compact Disc (CD) standard is followed by appearance of the Digital Versatile Disc (DVD) standard, and an HD DVD standard in which higher density than that of the DVD standard is achieved has already been put into practical use.

Therefore, there is a wide need for being able to record and reproduce the information in and from the optical discs pursuant to the HD DVD standard, the DVD standard, and the CD standard using a single optical head device.

For the recordable optical disc, in consideration of the reproduction with an optical disc apparatus different from an optical disc apparatus used in the recording, the intensity of the recording laser beam is managed such that a shape of a recording mark (pit) train falls within a specification, that is, a predetermined management width.

Therefore, an automatic power control (APC) circuit is prepared to maintain the intensity of the recording laser beam within a given range in most pieces of optical disc apparatus except for a playback-only optical disc apparatus. The APC circuit accepts the laser beam, in particular the recording laser beam, irradiated on a recording surface of the optical disc, and the APC circuit monitors the intensity of the recording laser beam to reflect the intensity on the laser element driving current.

For example, Japanese Utility Model Application Publication (KOKAI) No. H (heisei) 2-135920 discloses an optical disc apparatus which irradiates the optical disc with the light beam to record and reproduce the information in and from the optical disc. The optical disc apparatus has light quantity determination means and light quantity control means. In the optical disc apparatus, the light quantity determination means determines whether or not the light beam detected by a light quantity sensor has a proper light quantity, and the light quantity control means control so as to increase the light quantity of the light beam when the light quantity determination means determines that the light beam has the improper light quantity, thereby setting an optimum APC gain.

However, the Publication H (heisei) 02-135920, it is not considered that the information is recorded in each of the optical discs pursuant to the HD DVD standard, the DVD standard, and the CD standard using the single optical head device. Additionally, in this publication, the heavy dependence of the intensity (light quantity) of the laser beam incident to the APC detector on a laser beam wavelength of each optical disc standard or on energy of the recording laser beam and a countermeasure against the saturation of output of the APC detector are not discussed in Jpn. the UM. Appln. KOKAI Publication No. 2-135920. Because the laser beam for the CD standard differs from the laser beam for the HD DVD standard in the wavelength, it is known that a difference in energy of the recording laser beam reaches about 1000 times.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus according to an embodiment of the invention;

FIGS. 2A and 2B are exemplary diagrams each showing an example of a relationship between a gain of APC PD and an input light quantity in an optical disc apparatus, shown in FIG. 1, according to an embodiment of the invention;

FIG. 3 is a flowchart showing an example of a process of adjusting a light quantity of a laser beam fed into APC PD in an optical disc, shown in FIG. 1, according to an embodiment of the invention;

FIGS. 4A and 4B are exemplary diagrams each showing an example of an optical component used as a light quantity adjusting element in an optical disc, shown in FIG. 1, according to an embodiment of the invention;

FIG. 5 is an exemplary diagram showing an example of an optical component used as a light quantity adjusting element in an optical disc, shown in FIG. 1, according to an embodiment of the invention;

FIG. 6 is an exemplary diagram showing an example of an optical component used as a light quantity adjusting element in an optical disc, shown in FIG. 1, according to an embodiment of the invention;

FIG. 7 is an exemplary diagram showing another example of an optical head device of an optical disc apparatus, shown in FIG. 1, according to an embodiment of the invention; and

FIG. 8 is an exemplary diagram showing another example of an optical head device of an optical disc apparatus, shown in FIG. 1, according to an embodiment of the invention.

### DETAILED DESCRIPTION

Various embodiments according to the invention will be described hereinafter with reference to the accompanying drawings. In general, according to one embodiment of the invention, an optical disc device comprising: moving an actuator holding a lens which converges light from a light source on a recording layer of a recording medium to a predetermined position distant from the recording layer of the recording medium, and then locating the actuator in a direction to gradually approach the recording layer of the recording medium; finding, from a movement amount which inverts the polarity of an output of a photodetector, a first output obtained a predetermined amount before the movement amount which inverts the polarity of the output of the photodetector output by the movement of the lens, and a second output obtained a predetermined amount after the movement amount which inverts the polarity of the output of the photodetector, with regard to each of the surface of a transparent substrate of the recording medium and the recording layer thereof; finding the thickness of the transparent substrate at a plurality of radial positions in a recording surface of the recording medium and at a plurality of positions on the same radius, from the surface of the transparent substrate and the recording layer which have been found; and correcting a focal distance inherent in the lens by use of the thickness of the transparent substrate found at the plurality of radial positions in the recording surface of the recording medium and at the plurality of positions on the same radius.

Embodiments of this invention will be described in detail with reference to the drawings. In the following drawings, the same component is designated by the same numeral.

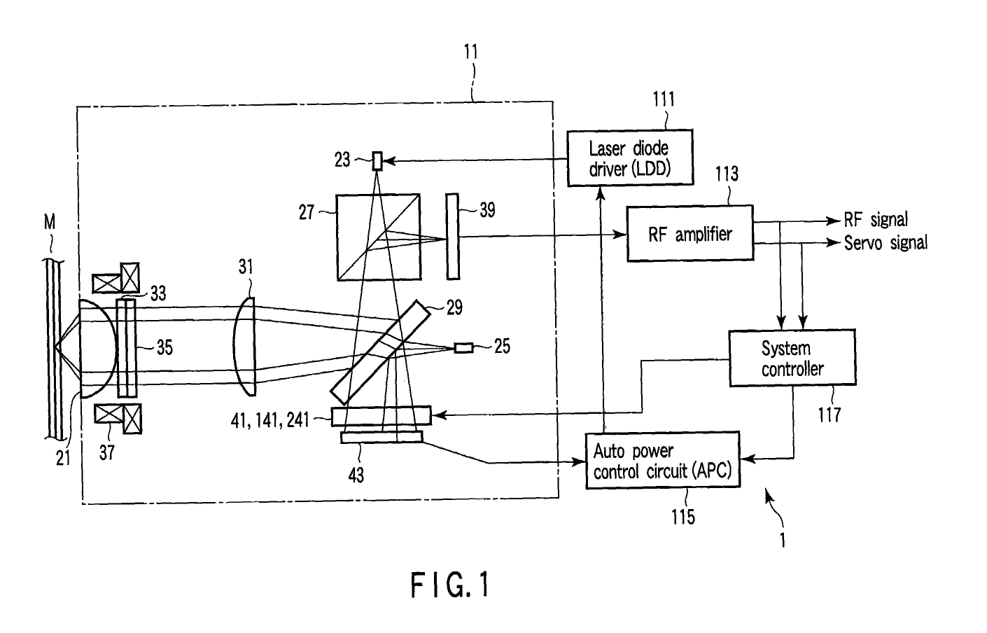

An optical disc apparatus 1 shown in FIG. 1 includes an optical pickup device (optical head device) 11. The optical head device 11 can record information in a recording layer (not described in detail) such as an organic film, a metal film, and a phase-change film of a recording medium (optical disc) M, and also, the optical head device 11 can read information recorded in the recording layer, and the optical head device 11 can erase information recorded in the recording layer.

Any already widely spread optical disc pursuant to an HD DVD standard, a DVD standard, and a CD standard can be used as the optical disc M, and sometimes at least two recording layers are laminated in the optical disc M. For at least the two recording layers, the recording layers pursuant to the different standards may be formed, and a hybrid disc in which the DVD standard and the HD DVD standard are already prepared in the single optical disc is also put to practical use.

Although not described in detail, the optical disc apparatus 1 has mechanical components such as a moving mechanism (not shown) and a disc motor (not shown). The moving mechanism moves the optical head device 11 along a recording surface of the optical disc M, and the disc motor rotates the optical disc M at a predetermined speed.

The optical disc apparatus 1, later further described, includes a laser diode driver (LDD) 111 incorporated into the optical head device 11, a signal processing circuit 113 which processes output of a photodetector accepting a light beam reflected from the optical disc M, an APC circuit 115 which processes output from a front monitor (APC) light acceptance element, and a system controller 117 which controls an APC circuit.

The optical head device 11 includes an objective lens 21 disposed approximate to the optical disc M. The objective lens 21 collects a laser beam emitted from a light source such as a laser diode which is a semiconductor laser element on to an arbitrary recording layer of the optical disc M, and the objective lens 21 takes in the laser beam reflected from an arbitrary recording layer of the optical disc M. The objective lens 21 is made of plastic, and the objective lens 21 has a numerical aperture NA of 0.65.

A first laser diode 23 and a second laser diode 25 are prepared as the semiconductor laser, that is, the laser diode (LD). The first laser diode 23 outputs a (blue) laser beam having a first wavelength to the optical disc pursuant to the HD DVD standard. The first wavelength ranges from 400 to 410 nm, and preferably 405 nm. The second laser diode 25 outputs a (red) laser beam having a second wavelength to the optical disc pursuant to the DVD standard. The second wavelength ranges from 645 to 660 nm, and preferably 650 nm. Sometimes an additional laser diode outputs a (near-infrared) laser beam having a third wavelength to the optical disc pursuant to the CD standard. The third wavelength ranges from 760 to 800 nm, and preferably 780 nm. In such cases, the laser diode outputting the laser beam having the third wavelength may be independently with the second laser diode 25, or obviously the laser diode supplying the laser beam having the third wavelength may be integrally provided although not shown.

A predetermined ratio of the laser beam emitted from the first semiconductor laser 23 passes through a polarization beam splitter (PBS) 27 provided at a predetermined position, and the predetermined ratio of the laser beam is partially (about 90% in the embodiment) reflected toward the objective lens 21 by a wavelength selective mirror (semi-transmissive mirror) 29. The wavelength selective mirror 29 regulates a reflectance of 90% with respect to the wavelength of 440 nm or less and a transmittance of 90% and a reflectance of 10% with respect to the wavelength of 600 nm or more.

A collimator lens 31 collimates the laser beam reflected by the semi-transmissive mirror 29, and a quarter-wave plate (that is, polarization control element) 33 rotates a polarization direction of the laser beam by a predetermined angle, and the laser beam is guided to the objective lens 21. A diffraction element or a hologram (diffraction) element 35 is integrally provided in the quarter-wave plate 33. The diffraction element or hologram (diffraction) element 35 is regulated based on a shape and an arrangement of a light acceptance area provided in a data photodetector (PD).

The objective lens 21 gives a predetermined focusing property to the laser beam guided to the objective lens 21. Then, the laser beam is transmitted through a cover layer (transparent substrate) of the optical disc M, not described in detail, and the laser beam is collected on one of arbitrary recording layers of the optical disc M (the laser beam emitted from the light source [laser diode, LD] exerts a minimum light spot at a focal position of the objective lens). In each recording layer of the optical disc M, a guide groove, that is, a track or a recording mark (already recorded data) train is formed in a concentric manner or a spiral manner with a pitch ranging from 0.34 to 1.6 μm.

Although not described in detail, the objective lens 21 is located at a predetermined position in a track direction and a predetermined position in a focus direction by an objective lens driving mechanism (actuator) 37. The objective lens driving mechanism 37 includes a driving coil and a magnet. The track direction is a direction traversing the track (recording mark train) in each recording layer of the optical disc M, and the focus direction is a thickness direction of the recording layer.

The objective lens 21 acquires (takes in) the laser beam reflected by an arbitrary recording layer of the optical disc M, and the objective lens 21 converts the laser beam into a laser beam having a substantially parallel shape.

Then, the reflected laser beam passes through the quarter-wave plate 33 to further rotate the polarization direction thereof, a predetermined property is given to the reflected laser beam by the diffraction element (hologram element) 35, and the reflected laser beam is incident to the collimator lens 31.

A predetermined ratio of the reflected laser beam incident to the collimator lens 31 is reflected toward the polarization beam splitter (PBS) 27 by the wavelength selective mirror 29 and guided to a light acceptance surface of the data PD 39 (photodetector, photodetector for data) by the polarization beam splitter 27. Although not described in detail, photodetection areas arranged into a predetermined shape are provided in the light acceptance surface of the data PD 39 while being able to generate servo signals such as an HF (reproduction) output signal, a track error signal TE, and a focus signal FE. The photodetection areas detect the reflected laser beam which is diffracted through the diffraction element (hologram element) 35 and focused by the focusing property given by the collimator lens 31, and the photodetection areas output a current corresponding to the light intensity. Usually (frequently) an amplifier which performs current-voltage (I/V) conversion to the output current is integrally provided in each photodetection area of the data PD, and the output from each photodetection area of the data PD is output as a voltage value.

The wavelength selective mirror 29 directly transmits a part (about 90% in the embodiment) of the laser beam having the wavelength of 650 nm, emitted from the second semiconductor laser element 25, toward the objective lens 21.

The collimator lens 31 collimates the laser beam transmitted through the wavelength selective mirror 29, and the quarter-wave plate (that is, polarization control element) 33 rotates the polarization direction of the laser beam by a predetermined angle, and the laser beam is guided to the objective lens 21.

The objective lens 21 gives a predetermined focusing property to the laser beam guided to the objective lens 21. Then, the laser beam is transmitted through the cover layer, not described in detail, (transparent substrate) of the optical disc M, and the laser beam is arbitrarily collected one of recording layers of the optical disc M (the laser beam emitted from the light source (laser diode) exerts the minimum light spot at the focal position of the objective lens).

The objective lens 21 acquires (takes in) the laser beam reflected by an arbitrary recording layer of the optical disc M, and the objective lens 21 converts the laser beam into the laser beam having a substantially parallel shape.

Then, the reflected laser beam, not described in detail, passes through the quarter-wave plate 33 to further rotate the polarization direction thereof, a predetermined property is given to the reflected laser beam by the diffraction element (hologram element) 35, and the reflected laser beam is incident to the collimator lens 31.

A predetermined ratio of the reflected laser beam incident to the collimator lens 31 is reflected toward the polarization beam splitter 27 by the wavelength selective mirror 29 and guided to the light acceptance surface of the data PD 39 by the polarization beam splitter 27.

An I/V conversion amplifier (not shown) converts the current output from each light acceptance portion of the data PD 39, not described in detail, into the voltage, and a signal processing circuit (RF amplifier) 113 performs computation in order to be able to utilize the voltage as the servo signals such as the HF (reproduction) signal output, the track error signal TE, and the focus error signal FE. The HF (reproduction) output signal, not described in detail, is converted into a signal having a predetermined signal format and supplied to a temporary storage device (not shown) or an external storage device (not shown) through a predetermined interface. The servo signals are also supplied to the system controller 117.

On the other hand, a light quantity adjusting element 41 changes a transmission light quantity of the laser beam emitted from the first semiconductor laser (LD) 23, transmitted through the polarization beam splitter (PBS) 27, and transmitted through the wavelength selective mirror 29 to a predetermined light quantity, and the laser beam is guided to an automatic power control (APC) photodetector (PD) 43. Similarly, the light quantity adjusting element 41 changes a transmission light quantity of the laser beam emitted from the second semiconductor laser (LD) 25 and reflected by the wavelength selective mirror 29 to a predetermined light quantity, and the laser beam is incident to APC PD 43.

Usually an area of APC PD 43 is formed larger than that of each photodetection area of the data PD in order to detect the laser beam which has the restricted light intensity compared with the light intensity of the recording or reproducing laser beam.

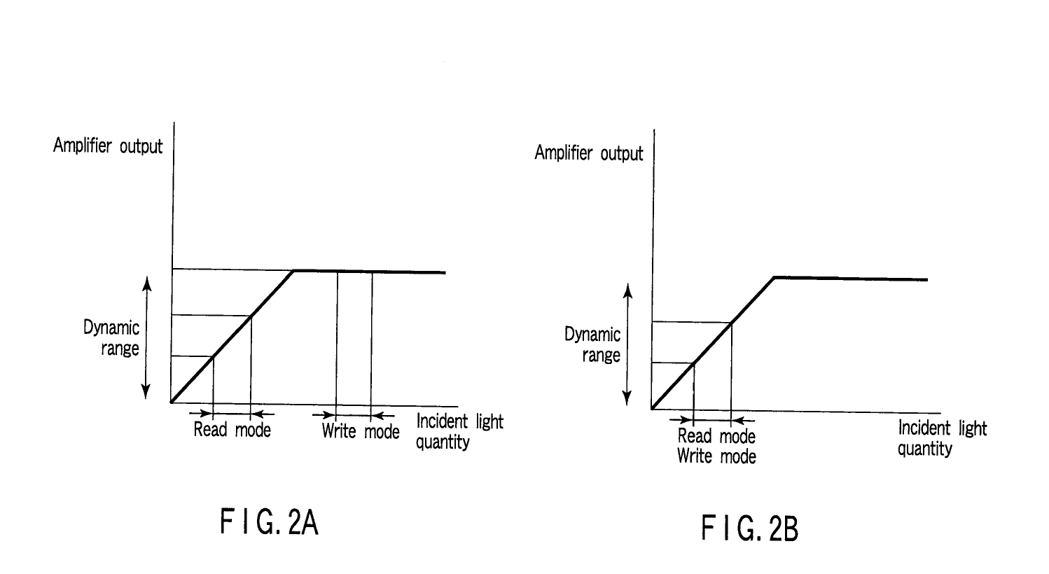

Therefore, as shown in FIG. 2A, in the case where APC PD 43 has sensitivity for the relatively weak laser beam during read (read mode, reproduction), sometimes APC PD 43 is saturated when irradiated with the laser beam having the high intensity during write (write mode, recording). That is, because the light quantity of the laser beam collected onto an arbitrary recording surface of the optical disc M during the write (write mode) is usually larger than that during the read (read mode), the light quantity of the laser beam incident to APC PD 43 during the write is similarly larger than that during the read, and the light quantity exceeds a dynamic range of an APC I/V conversion amplifier (not shown) or a post-stage amplifier to saturate APC PD 43.

Because of this situation, preferably a system controller controls the light quantity adjusting element 41 such that the light quantity falls within the dynamic range of the amplifier (I/V conversion amplifier) in both the read mode and the write mode. As shown in FIG. 2B, in order to use the optimum area in the dynamic range of the amplifier, preferably the transmittance of the light quantity adjusting element 41 is controlled such that the high transmittance is established in the read mode while the low transmittance is established in the write mode. That is, in both the read mode and the write mode, preferably the transmittance (attenuation amount) of the light quantity adjusting element 41 is set such that the intensity of the laser beam incident to the light acceptance area of APC PD 43 falls within the dynamic range of the amplifier.

The light quantity adjusting element 41 is particularly useful to the change of the kind of the disc in addition to the read mode/write mode. In the optical disc apparatus which is compatible with the optical discs pursuant to the different standards such as CD, DVD, BD (Blu-ray Disk [registered trademark]), and HD DVD, the wavelength and energy of the laser beam emitted from the light source depends on each standard. That is, in the common use optical head device in which the information is recorded in and reproduced from the optical discs pursuant to the HD DVD standard, the DVD standard, and the CD standard, sometimes photoelectric conversion is hardly performed without attenuation or amplification for at least one of the weak laser beam during the read mode for the optical disc pursuant to the CD standard and the strong laser beam during the write mode for the optical disc pursuant to the HD DVD standard. As is well known, usually the silicon-system PD has the higher sensitivity for the infrared light, the sensitivity is lowered as the wavelength is shortened, and sometimes the sensitivity is out of the dynamic range of the amplifier or only an extremely small part of the dynamic range can possibly be used.

This is particularly useful to the system (as shown in FIG. 1) in which distances between APC PD 43 and the first and second laser elements 23 and 25 and the number of optical components disposed in the optical path are largely changed. For example, the first laser element 23 differs from the second laser element 25 in the distance to APC PD 43, the wavelength selective mirror 29 is interposed between the first laser element 23 that is located distant from APC PD 43 and APC PD 43, the first laser element 23 emits the laser beam having the reproducing intensity, and the second laser element 25 emits the laser beam having the recording intensity. In such cases, the difference in intensity reaches about 1000 times. However, even in such cases, the transmission amount of the light quantity adjusting element 41 is controlled by receiving the output from the system controller 117 which makes the determination of the kind of the optical disc M based on the HF signal/servo signal, which allows the dynamic range of the amplifier to be efficiently used.

Accordingly, a relatively inexpensive PD (in this case, intend to use a single-function type PD without an amplifier equipped with gain control except for the I/V conversion amplifier) or a type of PD which is PDIC (integrated circuit [IC] equipped with the gain control) with having the small number of gain stages can be used as APC PD 43, so that cost reduction can be achieved.

Usually there is a substantially proportional relationship (distribution efficiency of objective lens/APC) between the intensity (light quantity) of the laser beam guided to APC PD 43 and the light quantity of the laser beam collected onto the target recording surface of the optical disc M based on the transmittance given to the wavelength selective mirror 29. The light quantity of the laser beam collected onto the target recording surface of the optical disc M is kept constant by utilizing the proportional relationship.

Therefore, the APC circuit 115 performs feedback control as follows. When the voltage fed into the APC circuit 115 which monitors the output of APC PD 43 is larger than an already learned setting value, the APC circuit 115 provides an instruction for decreasing the laser driving current to the light source control device, for example, the laser diode driver (LDD) 111 so as to decrease the intensity of the laser beam emitted from the semiconductor laser 23 or 25. On the other hand, when the voltage fed into the APC circuit 115 is smaller than the setting value, the APC circuit 115 increases the laser driving current to increase the light quantity of the laser beam such that the light quantity of the laser beam collected onto the target recording surface of the optical disc M is kept constant.

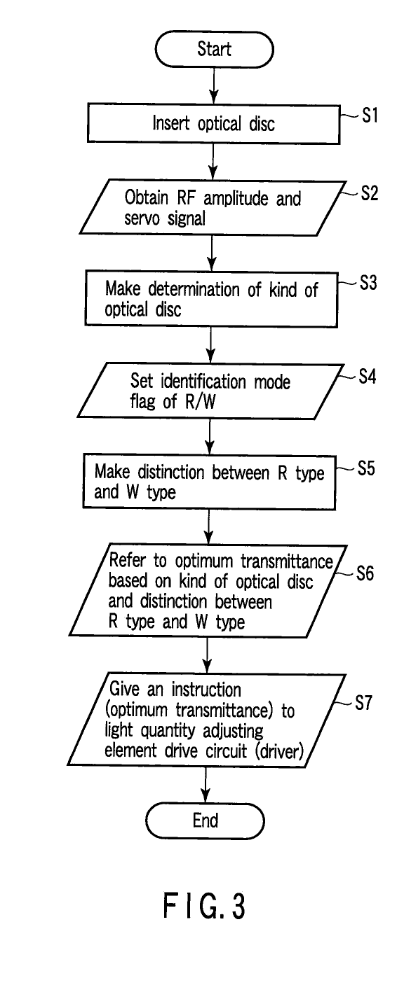

FIG. 3 is a flowchart showing an example of a process of utilizing the light quantity adjusting element to set the light quantity of the laser beam fed into APC PD.

The optical disc M having the recording surface pursuant to an arbitrary standard (format) is inserted into the optical disc apparatus 1 (Step S1).

Then, the second semiconductor laser element 25 emits the laser beam having reproducing (read, read mode) power, and the RF signal and the servo signal are obtained (Step S2). In the case where the third semiconductor laser element which can emit the laser beam having the third wavelength is provided, preferably the third semiconductor laser element emits the laser beam having the third (780 nm) wavelength and reproducing (read, read mode) power in order to prevent the overwrite of the data (information) already recorded in the recordable recording layer of the optical disc M.

Then, a determination of the kind of the optical disc is made based on the RF signal (amplitude) and servo signal obtained in Step S2. That is, the determination that the inserted optical disc M is the CD, DVD, BD, or HD DVD is made (Step S3).

Then, an identification mode flag is set to start up an R/W identification mode (Step S4). The identification mode flag is used to identify that the optical disc M is a read-only type, a write-once type (R type, data can be recorded only one time), or a rewritable type (W type, data can be erased). Then, a distinction between the R type and the W type is made (Step S5).

On the basis of the pieces of information on the kind of the optical disc and the distinction between the R and W types obtained in Steps S3 to S5, the optimum transmittance which should be adopted to the light quantity adjusting element 41 is specified by referring to a lookup table (LUT, not shown) stored in read-only memory (ROM, not shown) (Step S6).

The system controller (light quantity adjusting element control circuit/driver) 117 directs the optimum transmittance specified in Step S6 to be applied to the light quantity adjusting element 41, thereby setting the transmittance of the light quantity adjusting element 41 (Step S7).

Alternatively, after the transmission amount of the light quantity adjusting element 41 is set according to the flowchart of FIG. 3, the laser beam having the recording (write, write mode) power may temporarily be fed into APC PD 43 to check whether or not the setting value of the transmission amount of the light quantity adjusting element 41 falls within a predetermined range. A check whether or not the write can be tested within the dynamic range of APC PD, and a check whether or not the RF signal intensity is optimum in the read mode may be made to drive the light quantity adjusting element 41.

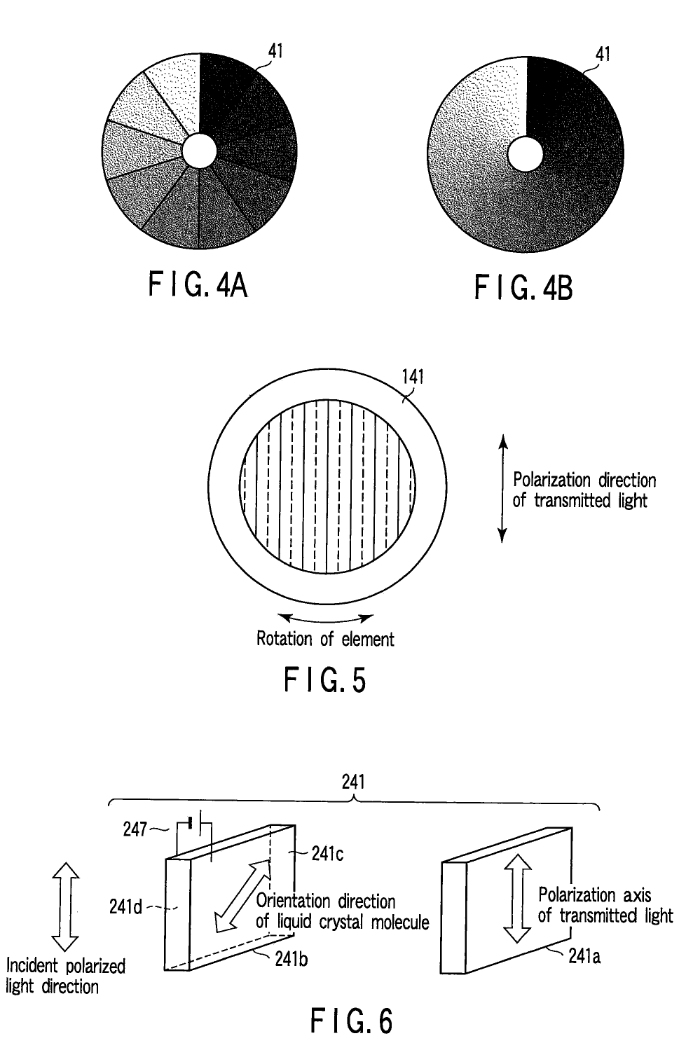

FIGS. 4A and 4B show examples of the optical component used as the light quantity adjusting element.

FIG. 4A shows an example of an optical element which can change the light quantity of the laser beam fed into APC PD 43 in a stepwise manner (in a multi-step manner), and FIG. 4A shows a neutral density (ND) filter to which plural kinds of density are given. As is well known, the ND filter has a function of decreasing the transmission amount. As shown in FIG. 4A, the different transmission amounts can continuously be given by disposing the areas (ND filter) having the different transmission amounts in a support body (base material) formed into a disc shape. Obviously the number of ND filters (the number of divided pieces, that is, the number of areas having the different kinds of density) is the number of pieces (the number of divided pieces) corresponding to the number of modes that are regulated according to the kind of the optical disc and the standard of the recording layer (R/W). As shown in FIG. 4B, the density of the filter portion may continuously be changed.

Obviously, the light quantity adjusting elements (ND filter) 41 shown in FIGS. 4A and 4B are located so as to shut out the optical path of the laser beam traveling from the wavelength selective mirror 29 toward APC PD 43, and the areas shutting off the optical path (portions having the different kinds of density) are displaced by a rotation mechanism (not shown) (for example, a worm gear and a driving motor).

FIG. 5 shows another example of the optical component used as the light quantity adjusting element.

A light quantity adjusting element 141 of FIG. 5 is, for example, a polarizing element. In the light quantity adjusting element 141, a rotation mechanism (not shown) (for example, a worm gear and a driving motor) changes the polarization directions of the laser beams output from the first and second semiconductor laser elements with respect to the polarization plane of the laser beam, which allows an arbitrary transmission to be provided.

FIG. 6 shows still another example the optical component used as the light quantity adjusting element.

A light quantity adjusting element 241 of FIG. 6 includes a polarizing filter (fixed) 241a and a liquid crystal display (LCD) 241b. Because the liquid crystal display 241b can change a refractive index in a certain polarization direction by the voltage, an orientation of the liquid crystal is inclined by 45 degrees with respect to the incident polarized light, whereby the incident polarized light can be changed from the linearly polarized light to the elliptically polarized light and the circularly polarized light. Accordingly, the polarizing filter 241a is disposed in the subsequent stage, which allows the transmission amount to be adjusted. At this point, the refractive index of the liquid crystal display 241b is arbitrarily set by applying the voltage between electrodes (transparent electrodes) 241c and 241d from a power supply device (refractive index control circuit) 247. The electrodes 241c and 241d are provided between an upper surface (light incident surface) and a lower surface (light outgoing surface) of the liquid crystal display 241b.

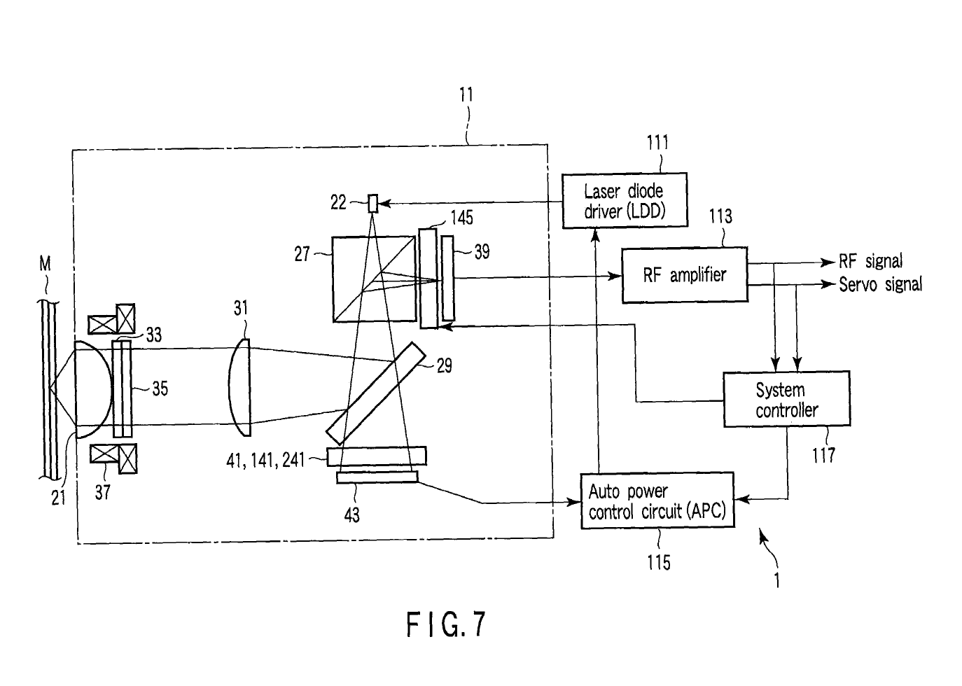

Alternatively, as shown in FIG. 7, a data PD light quantity adjusting element 145 having a configuration substantially similar to the light quantity adjusting element 41, 141, or 241 may be provided on the light incident side of the data PD 39. Therefore, an inexpensive type PD equipped only with the I/V conversion amplifier can be used as the data PD 39. Even if the PDIC (IC equipped only with the gain control) is used, the cost is reduced because the PDIC having the smaller number of stages can be used. In this case, obviously the system controller 117 is also used as the light quantity adjusting element 145. A light quantity adjusting control circuit (not shown) may be provided.

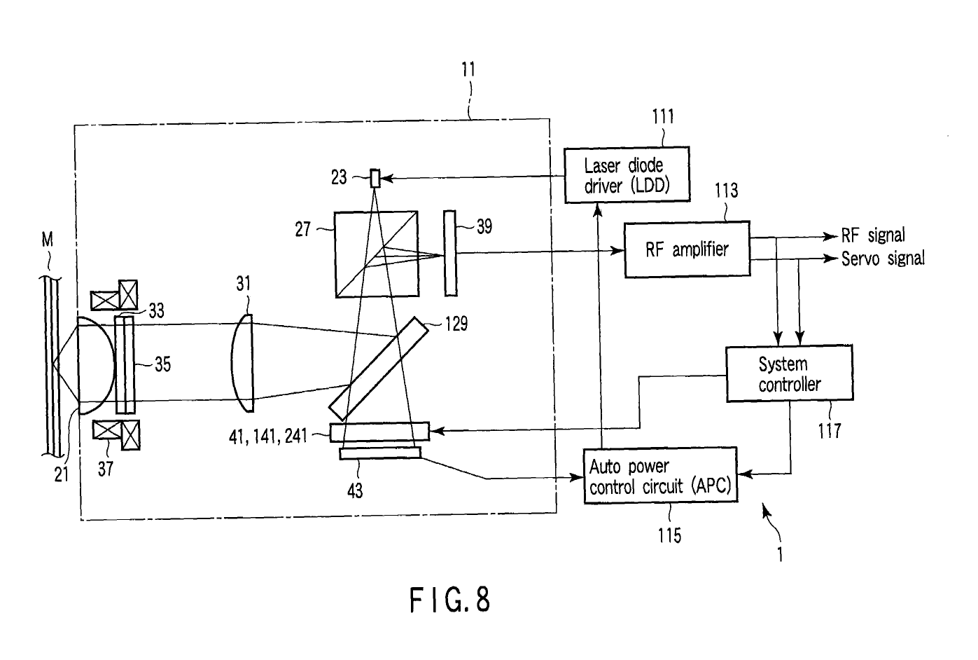

As shown in FIG. 8, in a system in which only the semiconductor laser element 23 which is the light source is provided, a semi-transmissive mirror 129 in which the transmittance and the reflectance are substantially set to 50% respectively is used as the mirror branches the laser beam incident to APC PD 43 and the laser beam toward the objective lens 21, and the light quantity adjusting element 41 is disposed even in the case where the laser beam incident to APC PD 43 has the relatively large light quantity. Therefore, the relatively inexpensive PD (the single-function type PD without the amplifier equipped with the gain control except for the I/V conversion amplifier) or a type of PD which is PDIC (IC equipped with the gain control) having the small number of gain stages can be used as APC PD 43, so that the cost reduction can be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head device comprising:
a light source which emits a light beam having a predetermined wavelength;
a branching device which branches a light beam to a recording layer of a recording medium with a predetermined ratio;
a light quantity controlling photodetector which accepts a light beam except for the light beam branched by the branching device and detects intensity of the light beam emitted from the light source;
a light quantity adjustment device which disposed between the branching device and the light quantity controlling photodetector to adjust intensity of the light beam except for the light beam branched by the branching device, the light beam except for the light beam branched by the branching device being incident to the light quantity controlling photodetector;
a light quantity adjustment device driving circuit which changes a transmission amount of the light quantity adjustment device while the intensity of light beam except for the light beam branched by the branching device can be changed, the light beam except for the light beam branched by the branching device passing through the light quantity adjustment device; and
a driving circuit which controls a driving current supplied to the light source based on output of the light quantity controlling photodetector.

2. An optical head device comprising:
a light source which emits a light beam having a predetermined wavelength;
a branching device which branches a light beam to a recording layer of a recording medium with a predetermined ratio;
a light quantity controlling photodetector which accepts a light beam except for the light beam branched by the branching device and detects intensity of the light beam emitted from the light source;
a light quantity adjustment device which disposed between the branching device and the light quantity controlling photodetector to adjust intensity of the light beam except for the light beam branched by the branching device, the light beam except for the light beam branched by the branching device being incident to the light quantity controlling photodetector;
a light quantity adjustment device driving circuit which changes a transmission amount of the light quantity adjustment device while the intensity of light beam except for the light beam branched by the branching device is able to be changed, the light beam except for the light beam branched by the branching device passing through the light quantity adjustment device;
a driving circuit which controls a driving current supplied to the light source based on output of the light quantity controlling photodetector;
a data photodetector which detects the light beam reflected by the recording surface of the recording medium and takes out information recorded in the recording surface of the recording medium;
a data detecting light quantity adjustment device which is located on an incident plane side of the data photodetector to adjust intensity of the light beam reflected by the recording surface of the recording medium, the light beam reflected by the recording surface of the recording medium being incident to the data photodetector; and
a light quantity adjustment device driving circuit which changes a transmission amount of each of the light quantity adjustment device while the intensity of light beam except for the light beam branched by the branching device and the intensity of the light beam reflected by the recording surface of the recording medium can be changed, the light beam except for the light beam branched by the branching device passing through the light quantity adjustment device, the light beam reflected by the recording surface of the recording medium being incident to the data photodetector.

3. The optical head device according to claim 1, wherein the light quantity adjustment device includes a polarizing filter which can continuously change the transmission amount.

4. The optical head device according to claim 2, wherein the light quantity adjustment device includes a polarizing filter which can continuously change the transmission amount.

5. The optical head device according to claim 1, wherein the light quantity adjustment device includes an ND filter in which density is set in multi-stage manner.

6. The optical head device according to claim 2, wherein the light quantity adjustment device includes an ND filter in which density is set in multi-stage manner.

7. The optical head device according to claim 1, wherein the light quantity adjustment device includes a liquid crystal display and a polarizing filter.

8. The optical head device according to claim 2, wherein the light quantity adjustment device includes a liquid crystal display and a polarizing filter.

9. An optical disc apparatus comprising:
an optical head device which includes;
a light source which emits a light beam having a predetermined wavelength,
a branching device which branches a light beam to a recording layer of a recording medium with a predetermined ratio,
a light quantity controlling photodetector which accepts a light beam except for the light beam branched by the branching device and detects intensity of the light beam emitted from the light source,
a light quantity adjustment device which disposed between the branching device and the light quantity controlling photodetector to adjust intensity of the light beam except for the light beam branched by the branching device, the light beam except for the light beam branched by the branching device being incident to the light quantity controlling photodetector,
a light quantity adjustment device driving circuit which changes a transmission amount of the light quantity adjustment device while the intensity of light beam except for the light beam branched by the branching device can be changed, the light beam except for the light beam branched by the branching device passing through the light quantity adjustment device, and
a driving circuit which controls a driving current supplied to the light source based on output of the light quantity controlling photodetector;
a data photodetector which detects the light beam reflected by the recording surface of the recording medium and takes out information recorded in the recording surface of the recording medium; and
a signal processing circuit which reproduces the information recorded in the recording surface of the recording medium from output of the data photodetector.

10. The optical disc apparatus according to claim 9, wherein the optical head device further comprising:
a data photodetector which detects the light beam reflected by the recording surface of the recording medium and takes out information recorded in the recording surface of the recording medium;
a data detecting light quantity adjustment device which is located on an incident plane side of the data photodetector to adjust intensity of the light beam reflected by the recording surface of the recording medium, the light beam reflected by the recording surface of the recording medium being incident to the data photodetector; and
a light quantity adjustment device driving circuit which changes a transmission amount of each of the light quantity adjustment device while the intensity of light beam except for the light beam branched by the branching device and the intensity of the light beam reflected by the recording surface of the recording medium can be changed, the light beam except for the light beam branched by the branching device passing through the light quantity adjustment device, the light beam reflected by the recording surface of the recording medium being incident to the data photo detector.

11. A method for controlling a light quantity of a light beam fed into a light quantity controlling photodetector of an optical head device, the method comprising:
accepting a light beam reflected from a recording layer of a recording medium and specifying a standard and a recording layer type of the recording medium;
obtaining information on intensity of a light beam which can be fed into the light quantity controlling photodetector based on the specified standard and recording layer type of the recording medium; and
operating a light quantity adjustment device based on the obtained intensity of the light beam which can be fed into the light quantity controlling photodetector, and maintaining the intensity of the light beam fed into the light quantity controlling photodetector within a predetermined range.

12. The light quantity control method according to claim 11, wherein the light quantity adjustment device is located on a light incident side of the light quantity controlling photodetector, and the light quantity adjustment device can change a transmission amount in a stepwise control manner or a continuous manner.
